(19) United States
(12) Patent Application Publication
(10) Pub. No.: US 2011/0184872 A1
(43) Pub. Date: Jul. 28, 2011

(54) METHODS AND SYSTEMS FOR PRIORITIZING CALL INITIATION IN A REAL ESTATE MANAGEMENT APPLICATION

(75) Inventors: Jeffrey McNeill, Sunnyvale, CA (US); James Wilson, Lafayette, CA (US); Joseph Trifoglio, Tracy, CA (US); Clayton Graham, Oakland, CA (US); Samuel Douglass, Berkeley, CA (US); Michael Davis, Pleasant Hill, CA (US)

(73) Assignee: ZipRealty, Inc., Emeryville, CA (US)

(21) Appl. No.: 13/027,098

(22) Filed: Feb. 14, 2011

Related U.S. Application Data
(60) Provisional application No. 61/428,753, filed on Dec. 30, 2010.

(51) Int. Cl. G06Q 50/00; H04M 3/42

(52) U.S. Cl. 705/313; 455/414.1

(57) ABSTRACT

A real estate service offers a management application for real estate agents to, for example, coordinate and manage real estate activities related to their clients. In one example, such a real estate application includes an embedded dialer application that includes several functionalities to develop a prioritized call initiation queue. In embodiments, the dialer retrieves and prioritizes all contacts associated with the agent using the dialer application. The dialer may utilize one or more of several mechanisms to prioritize the list of contacts to present the final call initiation queue to the user. The prioritization process takes several factors into account, such as, for example, the current availability of the client, a present geographic location of the client, an “emerging star” client, etc.

### CROSS REFERENCE TO RELATED APPLICATIONS

This application claims priority to U.S. Provisional Application No. 61/428,753, entitled REAL ESTATE MANAGEMENT APPLICATIONS filed Dec. 30, 2010, which is hereby incorporated by reference in its entirety.

This patent application is related to the technologies described in the following patents and applications, all of which are incorporated herein in their entireties:
U.S. patent application Ser. No. ______, entitled METHODS AND SYSTEMS FOR REAL ESTATE AGENT TRACKING AND EXPERTISE DATA GENERATION, filed concurrently herewith;
U.S. patent application Ser. No. ______, entitled METHODS AND SYSTEMS FOR TRANSMITTING LOCATION BASED AGENT ALERTS IN A REAL ESTATE APPLICATION, filed concurrently herewith;
U.S. patent application Ser. No. ______, entitled LEAD ALLOCATION IN REAL ESTATE APPLICATIONS USING INCOMING CLIENT′S GEOGRAPHIC POSITION, filed concurrently herewith;
U.S. patent application Ser. No. ______, entitled LEAD ALLOCATION IN REAL ESTATE APPLICATIONS USING DYNAMIC AGENT ALLOCATION WEIGHTAGES, filed concurrently herewith;
U.S. patent application Ser. No. ______, entitled VIRTUAL BIDDING PLATFORM FOR LEAD ALLOCATION IN REAL ESTATE APPLICATIONS, filed concurrently herewith.

### FIELD

The present invention generally relates to the field of electronic real estate management applications. More particularly, the present invention relates to methods and systems for prioritizing call initiation using such real estate management applications.

### BACKGROUND

The rapid growth in digital and Internet technology has revolutionized the real estate industry. These days, a vast majority of real estate transactions are performed online. Examples of such real estate transactions may include a client searching through online property listings, a real estate agent scheduling viewing-tours with clients, an agent drafting and transmitting offers for purchase of property, etc.

A real estate agent may typically have tens to hundreds of clients at any given time. In a competition-ridden market, an agent would have to make a concerted effort to keep in touch with her clients and also to periodically provide relevant information to ensure that the client's expectations are satisfied. However, given the number of clients on her roster at a given time, the agent would have to prioritize her call list to ensure that she gets makes effective use of her time. In one example, the agent would want to first call the clients that have expressed an interest in purchasing real estate immediately or within a relatively short period of time. In another example, a client may have indicated a time preference to receive calls from the agent, and the agent would have to prioritize her calls at a given time to ensure that she calls such clients first. In prior art methods, the agent would have to manually and painstakingly peruse through her list of contacts (and associated notes if any) to identify a prioritized list of contacts. Even such a manually prioritized list would not be a failsafe solution, as the list would have to be updated periodically to keep up with the constantly evolving changes in clients' priorities.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

As will be explained in the Detailed Description below, in one embodiment, a real estate service offers a management application for real estate agents to, for example, coordinate and manage real estate activities related to their clients. In one example, such a real estate application includes an embedded dialer application (or simply, “a dialer”) that includes several functionalities to develop a prioritized call initiation queue. In embodiments, the dialer retrieves and prioritizes all contacts associated with the agent using the dialer application. The dialer may utilize one or more of several mechanisms to prioritize the list of contacts to present the final call initiation queue to the user. The prioritization process takes several factors into account, such as, for example, the current availability of the client, a present geographic location of the client, an “emerging star” client, etc.

Since an agent may potentially have tens to hundreds or even thousands of contacts that he could potentially call, a prioritized list would enable the agent to most effectively use her time in calling only those clients that are likely to be productive from a business perspective. In prior art methods, the agent would manually have to select a list of contacts from a sequentially ordered list of contacts or perhaps call only a certain group of contacts that the agent earmarked for calling. However, the technology described herein enables the agent to have an automated procedure that takes a variety of factors into account to develop and present a prioritized list of contacts for the agent to call. Additionally, the call initiation queue may be automatically or manually refreshed periodically, ensuring that the agent is up to date with the continually evolving priorities.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIGS. 2A-2B depict an exemplary illustration of a real estate management application for use by a real estate agent;

FIGS. 3A-3D depict exemplary embodiments of the embedded dialer application that provides the agent with a prioritized call initiation queue;

FIG. 4 is a high-level block diagram showing an example of the architecture for a computer system; and

FIGS. 5A and 5B include a flow diagram depicting an embodiment of an overall process for operation of the dialer application.

The headings provided herein are for convenience only and do not necessarily affect the scope or meaning of the claimed invention.

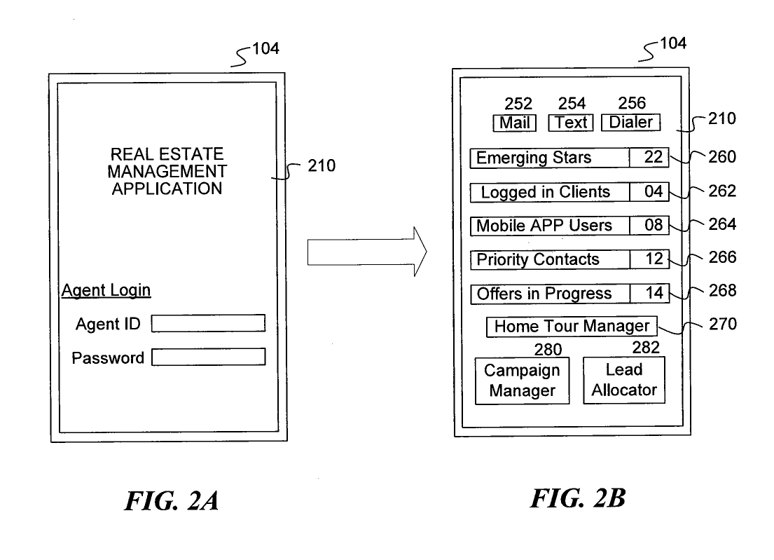

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

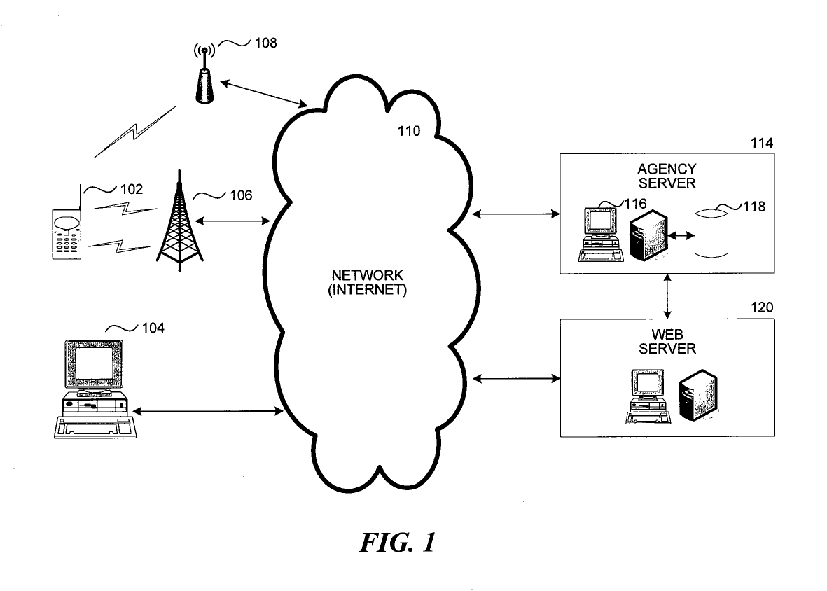

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to an agency server 114 through the network 110. In one embodiment, the agency server 114 comprises a server computer 116 coupled to a local database 118. The term “agency server” as indicated herein, refers to a server station or other computing apparatus capable of hosting a web service that is accessible by other computing systems (e.g., the personal computer 104) through, for example, the Internet.

In embodiments, the agency server 114 illustrated in FIG. 1 operates, or offers for operation, an electronic real estate management application. The term “electronic real estate management application” (or simply, a “real estate service”) as indicated herein, refers to a suite of operations or applications that may include, for example, a management application for real estate agents. As will be explained in further detail herein, such an application would allow the agent to, for example, manage and coordinate user profiles or potential buyers (or clients) engaged with the agent for the purpose of purchasing real estate in a particular location, managing offer submission and contract generation, managing and overseeing client activity, establish communication with clients through one or more communication media (e.g., embedded telephone application, embedded text or email application, etc.), track client location, publish agent's present geographic location, etc. The agency server 114 may utilize the associated database 118 to store and manage contact information and all other data related to the above mentioned examples.

In embodiments, the functionalities of the real estate service may be processed entirely within the agency server 114, operated via a graphical user interface from the user's computing device (102 or 104). For example, the agency server 114 may offer a web based interface to the various functionalities, allowing a user to control or operate the functionalities using web based interfaces via the user's computing device. In such instances, the agency server 114 handles all database related operations (e.g., retrieving the contacts associated with an agent, retrieving user profile information, retrieving previously saved contracts and other paperwork for a particular client, etc.) in a client-server architecture, allowing the computing device to receive and display such information. In embodiments, however, it is understood that the functionalities of the real estate service described herein may be handled and operated entirely in a stand-alone manner entirely from the computing device. It is further understood that the exemplary functionalities described herein may be performed in any other architecture as may be understood by a person of ordinary skill in the art.

As indicated in the example above, in some instances, the agency server 114 may also operate as a web server to enable the functionalities of the real estate service to be offered over a local network or the Internet. In such instances, the agency server 114 may operate additionally as a web server or may be coupled to a separate web server 120 to provide the web functionalities. Further, as shown in FIG. 1, the personal computing devices (e.g., 102, 104) and the agency server 114 are connected through the network 110 to one or more web servers (e.g., web server 120).

As will be explained in additional detail below, in one embodiment, the real estate service offers a management application for real estate agents to, for example, coordinate and manage real estate activities related to their clients. In one example, such a real estate application includes an embedded dialer application (or simply, “a dialer”) that includes several functionalities to develop a prioritized call initiation queue. In embodiments, the dialer retrieves and prioritizes all contacts associated with the agent using the dialer application. The term “contacts,” as described herein, may include a prospective real estate purchaser, a current client who is actively in the process of purchasing real estate, a person interested in real estate related information, or any person or entity that the real estate agent intends to communicate with. The dialer may use one or more of several mechanisms to prioritize the list of contacts to present the final call initiation queue to the user. The prioritization process takes several factors into account, such as, for example, the current availability of the client, a present geographic location of the client, an “emerging star” client, etc.

Since an agent may potentially have tens to hundreds or even thousands of contacts that he could potentially call, a prioritized list would enable the agent to most effectively use her time in calling only those clients that are likely to be productive from a business perspective. In prior art methods, the agent would manually have to select a list of contacts from a sequentially ordered list of contacts or perhaps call only a certain group of contacts that the agent earmarked for calling. However, the technology described herein enables the agent to have an automated procedure that takes a variety of factors into account to develop and present a prioritized list of contacts for the agent to call.

For purpose of further illustration, it is useful to consider the techniques explained herein as it applies to dialers embedded in real estate applications utilized by real estate agents. Of course, however, it should be noted that the techniques introduced herein may also extend to non-real-estate applications where a prioritized call initiation queue may be warranted based on multiple priority bases.

FIGS. 2A-2B depict an exemplary illustration of a real estate management application for use by a real estate agent. In one embodiment, an agent invokes the real estate management application (real estate application) 210 on a computing device 104. As illustrated in FIG. 2A, the real estate application first requires the agent to login to a service account associated with the agent. Upon logging in, the real estate application 210 presents an overview page, presenting the various functionalities available to the agent, as illustrated in FIG. 2B. It is noted that FIG. 2B is merely an exemplary depiction of some of the potential features available to the agent, and is not intended as a comprehensive embodiment. In the example of FIG. 2B, the agent is presented with a list of contacts associated with the agent. In one example, the real estate service 210 groups the contacts under one or more categories. For example, a first category 260 groups all contacts (22 contacts in this example) that have previously been designated as emerging stars. As described herein, an emerging star could be a client that shows immense potential value in purchasing a property in the immediate future, or one that purchases real estate properties on a regular basis, or simply any client that is attractive to the agent from a business perspective. In another example 262, the real estate service 210 groups all clients that are currently logged into to a corresponding real estate application offered for clients. Other examples include clients grouped as users of the real estate application from a mobile device (e.g., a smart phone) 264, priority contacts 266, clients who currently have an offer in progress 268, etc. It is conceivable that the same contacts could be grouped under two or more of these 4 categories (e.g., a currently logged in client could also be a priority contact, etc.).

Additionally, the overview page presents other options that would be of use to the agent. For example, links to a dialer 256, a texter 254 (i.e., an application allowing SMS text messages to be transmitted), a mailer 252 (i.e., an application allowing the agent to communicate via email messages), etc. may be included. Additionally, links to a lead allocator 282 (for managing allotment and intake of clients) and a campaign manager 280 may also be included. Each of these features will be discussed in detail as appropriate in the following sections.

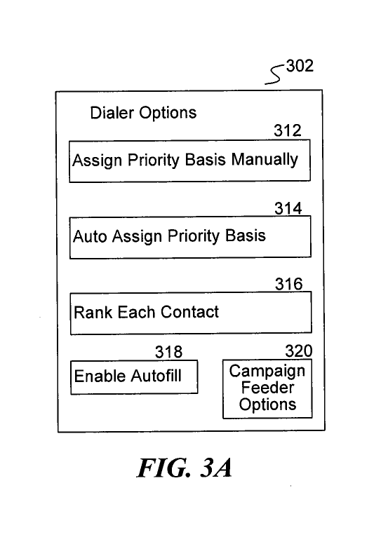

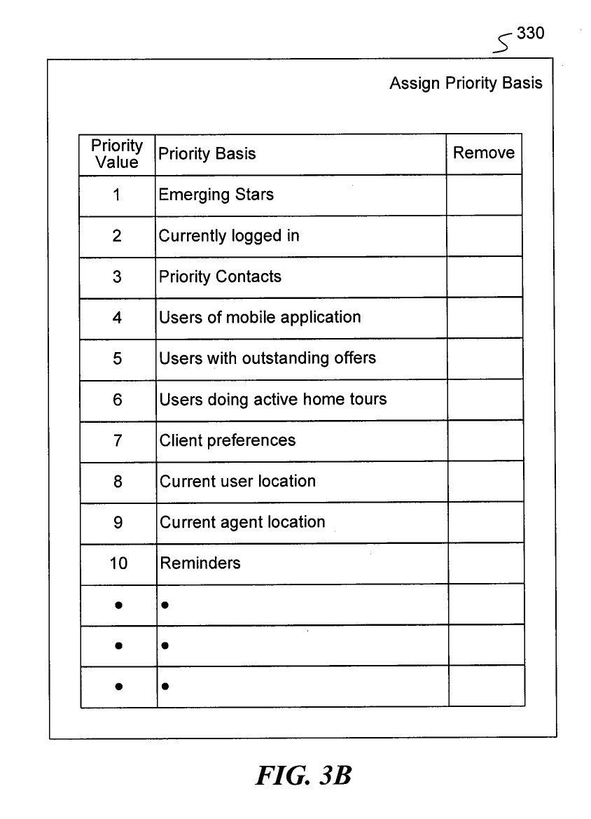

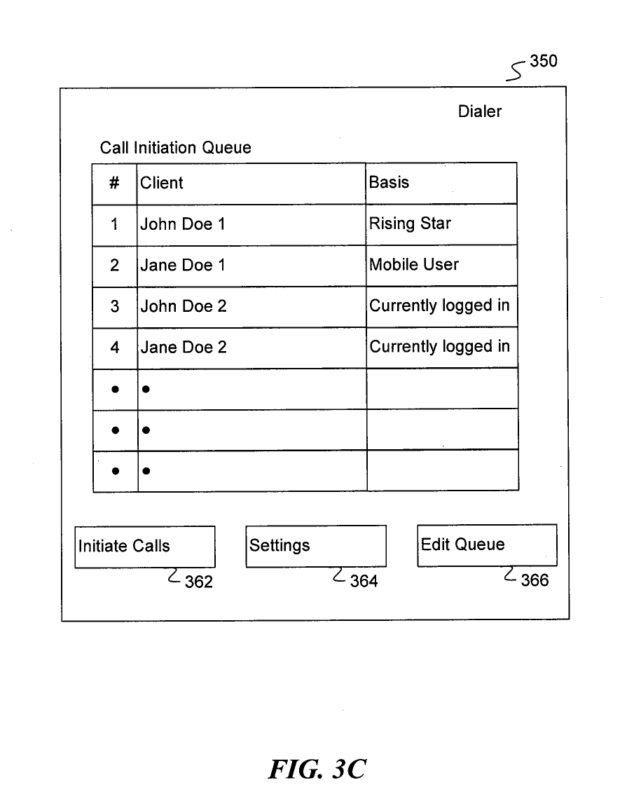

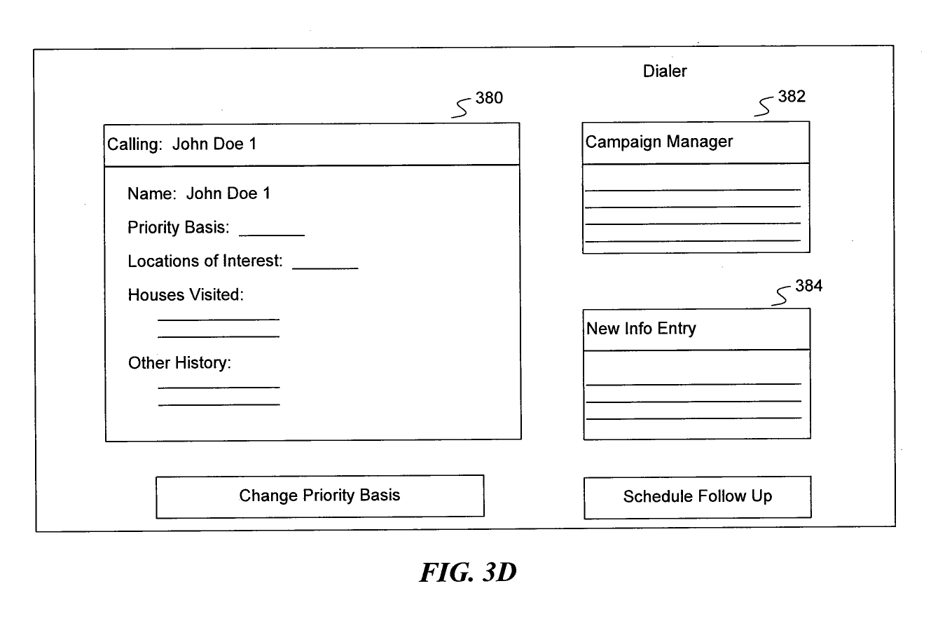

FIGS. 3A-3D depict exemplary embodiments of the embedded dialer application that provides the agent with a prioritized call initiation queue. When an agent selects the dialer application 256 from the overview page, in some embodiments, the agent may directly be provided with a dialing application that enables the agent to make a call. In some instances, the agent may make appropriate personalization selections to instead be presented with a call initiation queue. In embodiments, as illustrated in FIG. 3A, the dialer application 256 may include a setting panel 302 allowing the agent edit customization settings.

In some instances, the setting panel 302 may include a first option 312 allowing an agent to establish a manual priority basis. The term “priority basis” as referred to herein, describes a basis for categorization of the clients. As explained briefly in the previously section, an example of a categorization may be an “emerging star” categorization or a “currently logged in” categorization. Further examples of categorization for priority basis are discussed below with reference to FIG. 3B. Instead of assigning priority to each individual contact, the agent may wish to simply assign priority on the basis of each category. In one example, the agent may consider it a higher priority to call clients that are “currently logged in” as opposed to clients that are “priority contacts.” Given the agent's preferences and choice, the agent may use the “assign priority basis manually” 312 link to assign a ranking or priority status for each of the priority bases (as will further be described with reference to FIG. 3B).

A second option, the “auto assign priority basis” 314 option allows the agent to subscribe to a pre-established ranking for the priority bases. For example, the agency server may maintain a current version of ranking of the priority bases to ensure that all agents subscribing to the services of the agency server operate uniformly (or apply uniform ranking). Upon selecting this link, in embodiments, the dialer application may communicate with, for example, the agency server, to receive a current designation of rankings for each priority basis. The dialer application would then assign this ranking to generate the call initiation queue, without requiring the agent to go through the process of assigning a ranking to the priority bases. In an alternative example, instead of receiving the ranking information from the agency server, the auto assign link 314 may simply assign priority bases according to the previous ranking designated by the user in a prior session.

In addition to the above options, the settings panel 302 may also present a link 316 allowing the agent to rank each contact individually (i.e., independent of any priority basis).

An “enable autofill” 318 option may be selected to allow certain information to be collected from a client during an ongoing call between the client and the agent through the dialer. As will be discussed in detail below with reference to FIG. 3D, the dialer presents profile information about the client and other “talking points” to enable the agent to engage in a personalized conversation with the client. If there is any missing information in the profile (e.g., if the profile does not indicate which neighborhood a client is interested in), the agent can fill in the information in an editor section of the dialer during the call. Additionally, or in lieu of such a functionality, the dialer may also automatically capture such information during the conversation. In one example, the dialer may use speech recognition capabilities to detect specific responses from the conversation to auto fill missing information. Selecting the “enable autofill” feature 318 would invoke such a functionality.

FIG. 3B depicts an exemplary interface of the dialer application that allows an agent to assign a priority or ranking value to each of the priority bases. In the exemplary illustration, the list of priority bases include client groupings based on clients that are emerging stars, clients that are currently logged in, clients that are priority contacts, clients that consistently use a mobile device to access the real estate management application, clients that have outstanding offers to purchase homes, clients that are in the process of doing home tours, based on previously established client preferences (e.g., client preference indicating they would like to be called only on Monday evenings, etc.), based on the client's current geographic location (e.g., clients that are currently located in a geographic area where they are interested in purchasing houses are probably doing a home tour or canvassing the neighborhood, and therefore should be prioritized for calls from their agents), based on the agent's current geographic location (e.g., when an agent is a neighborhood in which a particular client has previously expressed interest in, the particular client should be prioritized), based on reminders previously established by the agent, etc. In embodiments, the agent would have options to remove a priority basis or add and define other new priority bases.

As illustrated above, it can be readily observed that the agent's call initiation queue will dynamically vary depending on the time of the day or the agent's current location or the agent's or the user's present activities. Since the priority list is constantly evolving, the agent would merely need to refresh the call initiation queue to ensure that he takes the best advantage, for example, of the current status of his clients. In some embodiments, the call initiation queue automatically refreshes periodically (e.g., every five minutes) to ensure that the call initiation queue reflects the latest status of the agent and the clients. Additionally, or in lieu of the auto refresh, the agent may manually refresh the list using a refresh option.

Based on the ranking scheme, it is conceivable that clients categorized within the same priority basis may receive different ranking. For example, a first client may only be categorized under the “emerging stars” category, while a second client may be categorized under both the “emerging stars” and the “currently logged in” categories at a given time. A third client may be categorized under both “priority contacts” and “emerging stars” categories. Depending upon the ranking assigned to each of these priority bases, the second client may be ranked over the third client (i.e., if the “currently logged in” basis has a higher ranking than the “priority contacts” category), and the first client may be ranked below the second and third clients.

In some instances, the dialer may issue alerts based on changes in the call initiation queue. For example, when the user is not presently using the dialer application, or when the user is in a long call with a client, the dialer application may issue a prompt (e.g., a text message, an alert message on the phone, etc.) to indicate that there is a change in the call initiation queue. This would allow the agent to readily take advantage of such a change. In an illustrative example, assume the agent is on a long conversation with a client designated as an emerging star. During this call, another client, who is originally designated under “emerging stars” logs in to the real estate service using a mobile device. Accordingly, the user would now also be categorized under the following two priority bases: “currently logged in” and “user of mobile application.” Therefore, the potential value in calling this client would probably be higher than a client who is designated only under the “emerging star” priority bases. The dialer application, which is under an auto-refresh, would refresh the list to reflect these changes, and issue an alert to the agent, allowing the agent to make a suitable determination.

FIG. 3C depicts an exemplary embodiment of a call initiation queue 360. The call initiation queue includes a list of contacts that are arranged in a specific order based on a pre-assigned ranking. As discussed with reference to FIG. 3A, the ranking may be automatically or manually assigned. In some instances, in addition to the name of the client, the call initiation queue 360 may also indicate the priority basis for the client, enabling the agent to readily perceive the importance in calling a particular contact. In addition to the call initiation queue 360, the dialer application may also provide options to allow the agent to manually edit the list 366, or further change settings 364, or to simply initiate the process of calling the contacts 362 according to an order indicated in the call initiation queue 360.

FIG. 3D is an exemplary depiction of the dialer application subsequent to initiation of a call with a given client. Here, subsequent to establishing a call with a first client, the dialer application displays an information section 380 with quick information about the client. Additionally, the dialer application includes a campaign manager 382 which provides talk points based on information presently known about the client. By presenting these talk points using the client's profile information, the agent is presented with the option of personalizing her conversation with the client. Additionally, the dialer application includes a new info entry section 384, enabling the agent to include new information that the client may provide during the call. If an auto-fill option is chosen, in some instances, the dialer application may also use speech recognition capabilities to automatically retrieve important or missing information and enter such information within the client's profile. In addition to the above options, the dialer may also include options to enable the agent to change priority basis of the client, and also to schedule follow up reminders to call the client.

In some instances, the new information is then propagated to other sections of the real estate management application (e.g., the campaign manager section, the emerging stars section, etc.) to allow suitable changes to occur within such sections. For example, if the client was previously not categorized as an emerging star, but should now be considered one based on information the client provided during the call, the agent would make a note of such information in, for example, the new info entry section or change priority basis section. Accordingly, the changes would propagate through the system, and the client would automatically get added to the “emerging stars” category, and would thus, for example, be accessible through the “emerging stars” link in the overview page (refer to FIG. 2B) of the real estate management application.

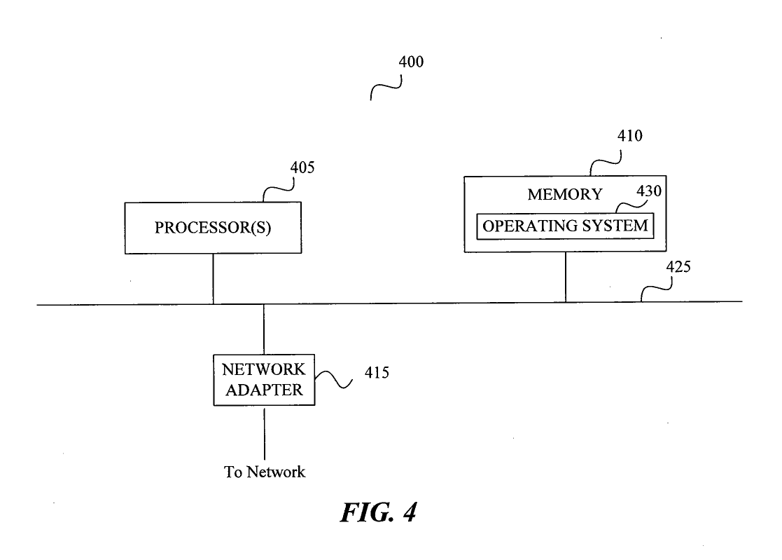

FIG. 4 is a high-level block diagram showing an example of the architecture for a computer system 400 that can be utilized to implement a agency server (e.g., 114 from FIG. 1), a web server (e.g., 125 from FIG. 1), a computing device (102, 104), etc. In FIG. 4, the computer system 400 includes one or more processors 405 and memory 410 connected via an interconnect 625. The interconnect 425 is an abstraction that represents any one or more separate physical buses, point to point connections, or both connected by appropriate bridges, adapters, or controllers. The interconnect 425, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 605 may include central processing units (CPUs) to control the overall operation of, for example, the host computer. In certain embodiments, the processor(s) 405 accomplish this by executing software or firmware stored in memory 410. The processor(s) 405 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 410 is or includes the main memory of the computer system 1100. The memory 410 represents any form of random access memory (RAM), read-only memory (ROM), flash memory (as discussed above), or the like, or a combination of such devices. In use, the memory 410 may contain, among other things, a set of machine instructions which, when executed by processor 405, causes the processor 405 to perform operations to implement embodiments of the present invention.

Also connected to the processor(s) 405 through the interconnect 425 is a network adapter 415. The network adapter 415 provides the computer system 400 with the ability to communicate with remote devices, such as the storage clients, and/or other storage servers, and may be, for example, an Ethernet adapter or Fiber Channel adapter.

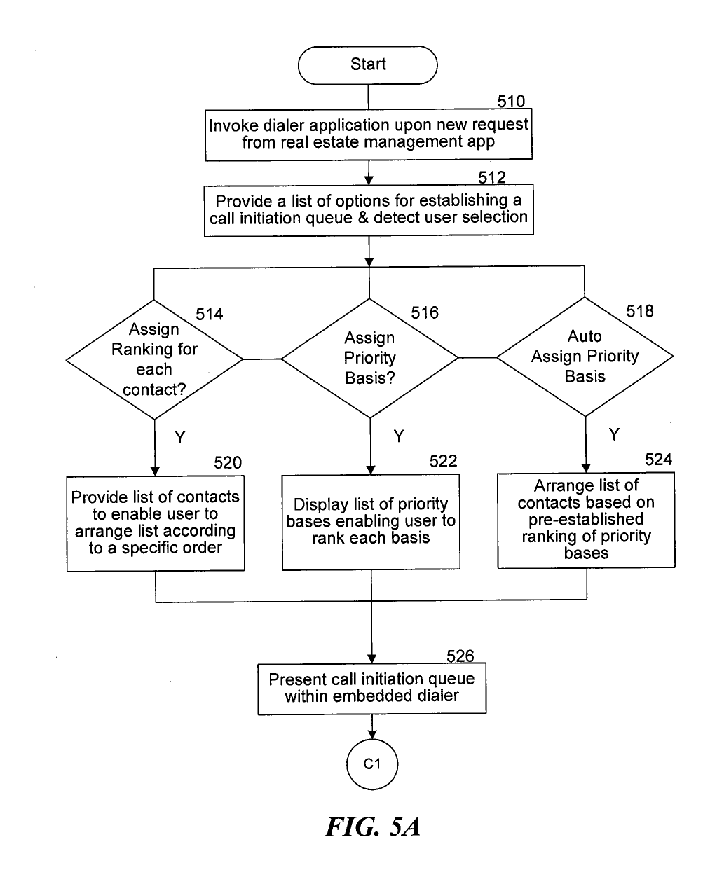

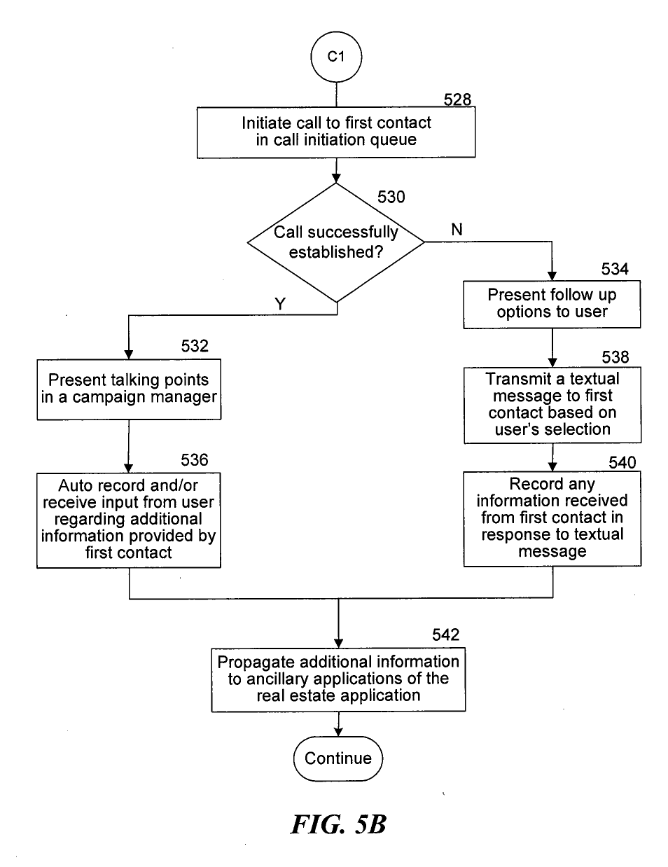

FIGS. 5A and 5B include a flow diagram depicting an embodiment of an overall process for operation of the dialer application. Step 510 signifies the start of the process, where an agent invokes the dialer application utilizing the real estate management application. Subsequently, at step 512, the process provides a list of options for establishing a call initiation queue. In the embodiment described here, the agent may choose one of three options. In a first option 514, the user may manually assign a ranking for each contact, in which case, the process retrieves (e.g., from the database of the agency server) a list of available contacts to enable the agent to arrange the call initiation queue according to a specific order, as indicated in step 520. In a second option 516, the agent may choose to assign a ranking for each priority basis, in which case the process provides, in step 522, a list of priority bases for the user to rank. In a third option 518, the agent may choose to assign ranking automatically based on pre-established ranking basis, in which case the list of contacts are automatically arranged according to a specific order. The process then converges at step 526, where a call initiation queue is established according to the specific order and is then displayed via the embedded dialer.

Subsequently, when the agent places a call at step 528, the dialer initiates a call with the first contact listed in the call initiation queue. If a call is successfully established, as indicated in step 532, the dialer presents talking points from a campaign manager, enabling the agent to personalize his conversation with the first contact. Subsequently, at step 536, the dialer also optionally records (e.g., by allowing the agent to manually enter information or by using speech recognition techniques) new information to be added to the first contact's profile. If a call is not successfully established at step 530, the process proceeds to step 534, where the dialer presents options to allow follow up with the first contact. In one example, the process may allow the user to send a textual message (e.g., an SMS text message or an email message) to the first contact, as indicated in step 538. If any responses are received to these messages, the process further captures any new information from such messages and uses the new information to update the first contact's profile, as indicated in step 540. Finally, at step 542, the process propagates any changes in the first contact's user profile to other ancillary applications (e.g., emerging stars application, campaign manager application, etc.) of the real estate application.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. § 112, sixth paragraph, other aspects may likewise be embodied as a means-plus-function claim, or in other forms, such as being embodied in a computer-readable medium. (Any claims intended to be treated under 35 U.S.C. § 112, ¶6 will begin with the words “means for.”) Accordingly, the applicant reserves the right to add additional claims after filing the application to pursue such additional claim forms for other aspects of the invention.

We claim:

1. A method of initiation and placement of telephone calls using an embedded dialer application in an electronic real estate management application, the method comprising:
retrieving a plurality of contacts for placement within a call initiation queue of the dialer application, wherein each of the plurality of contacts is indicative of a client a real estate agent intends to establish communication with via the electronic real estate management application;
assigning a priority value for at least a subset of the retrieved contacts based on one or more priority bases associated with the real estate management application;
automatically arranging the plurality of contacts within the call initiation queue in a specific order based on the priority value associated with each of the plurality of contacts; and
initiating communication with one or more of the plurality of contacts by the embedded dialer application according to the specific order of the contacts within the call initiation queue.

2. The method of claim 1, wherein the priority value for each of said subset of retrieved contacts is manually assigned by the real estate agent.

3. The method of claim 1, wherein the priority value for each of said subset of retrieved contacts is assigned automatically based on a ranking of the one or more priority bases.

4. The method of claim 3, wherein the ranking is pre-established by an agency server operating in communication with the real estate management application.

5. The method of claim 3, wherein the ranking is manually assigned by the real estate agent in conjunction with the operation of the electronic real estate management application.

6. The method of claim 1, wherein the one or more priority bases associated with the real estate management application includes at least one of:
a priority based on one or more clients designated as priority contacts;
a priority based on one or more clients designated as emerging stars;
a priority based on one or more clients designated as users of a mobile version of a client real estate management application;
a priority based on one or more clients designated as having made a recent offer for purchase of a real estate property;
a priority based on one or more clients designated as having made a recent tour of a home in a neighborhood associated with the real estate agent;
a priority based on one or more clients designated as having elected to receive calls at a specific time duration;
a priority based on the real estate agent's current geographic location;
a priority based on a current geographic location of one or more clients;
a priority based on specific reminders assigned by the real estate agent to one or more clients; or
a priority based on an increase in real estate activity of one or more clients.

7. The method of claim 1, wherein, subsequent to initiating a telephone call with a first contact of the plurality of contacts, the embedded dialer application displays a talking points board using previously known personal details about the first contact, and further enables the real estate agent to incorporate updated information into the first contact's profile.

8. The method of claim 7, wherein, the embedded dialer application utilizes a speech recognition routine to identify, from the conversation with the first contact, details missing from the first contact's personal profile.

9. The method of claim 7, wherein, if the embedded dialer application is unsuccessful in attempting to establish a telephone call with the first contact, the embedded dialer application subsequently provides a text interface that includes known personal details about the first contact, enabling the real estate agent to draft a customized textual message to be sent to the first contact via the embedded dialer application.

10. The method of claim 7, wherein, subsequent to an update in the first contact's profile, the embedded dialer application reports a change in the first contact's status to the electronic real estate management application, further wherein the electronic real estate management application reassesses the priority value of the first contact based the changed status.

11. A system for initiation and placement of telephone calls using an embedded dialer application in an electronic real estate management application, the system comprising:
a database comprising a plurality of contacts for placement within a call initiation queue of the dialer application, wherein each of the plurality of contacts is indicative of a client a real estate agent intends to establish communication with via the electronic real estate management application
a computing device for operating the dialer application within the electronic real estate management application, the computing device configured to:
retrieve the plurality of contacts for placement from the database;
assign a priority value for at least a subset of the retrieved contacts based on one or more priority bases associated with the real estate management application;
automatically arrange the plurality of contacts within the call initiation queue in a specific order based on the priority value associated with each of the plurality of contacts; and
initiate communication with one or more of the plurality of contacts by the embedded dialer application according to the specific order of the contacts within the call initiation queue.

12. The system of claim 11, wherein the priority value for each of said subset of retrieved contacts is assigned by one or more of:
manual assignment by the real estate agent of the one or more priority bases;
automatic assignment based on a first ranking of the one or more priority bases, wherein the first ranking is pre-established by an agency server operating in communication with the real estate management application; or
automatic assignment based on a second ranking of the one or more priority bases, wherein the second ranking is manually assigned by the real estate agent in conjunction with the operation of the electronic real estate management application.

13. The system of claim 11, wherein the one or more priority bases associated with the real estate management application includes at least one of:
a priority based on one or more clients designated as priority contacts;
a priority based on one or more clients designated as emerging stars;
a priority based on one or more clients designated as users of a mobile version of a client real estate management application;
a priority based on one or more clients designated as having made a recent offer for purchase of a real estate property;
a priority based on one or more clients designated as having made a recent tour of a home in a neighborhood associated with the real estate agent;
a priority based on one or more clients designated as having elected to receive calls at a specific time duration;
a priority based on the real estate agent's current geographic location;
a priority based on a current geographic location of one or more clients;
a priority based on specific reminders assigned by the real estate agent to one or more clients; or
a priority based on an increase in real estate activity of one or more clients.

14. The system of claim 1, wherein the dialer application operated by the computing device is further configured to:
subsequent to initiating a telephone call with a first contact of the plurality of contacts, display a talking points board using previously known personal details about the first contact, and further enable the real estate agent to incorporate updated information into the first contact's profile.

15. The system of claim 14, wherein, if the embedded dialer application is unsuccessful in attempting to establish a telephone call with the first contact, the embedded dialer application subsequently provides a text interface that includes known personal details about the first contact, enabling the real estate agent to draft a customized textual message to be sent to the first contact via the embedded dialer application.

16. The system of claim 14, wherein, subsequent to an update in the first contact's profile, the embedded dialer application reports a change in the first contact's status to the electronic real estate management application, further wherein the electronic real estate management application reassesses the priority value of the first contact based the changed status.

17. The system of claim 11, wherein the database is maintained in conjunction with an agency server that is remotely in communication with the computing device.

18. The system of claim 11, wherein the database is maintained locally in conjunction with the computing device.

19. A system for initiation and placement of telephone calls using an embedded dialer application in an electronic real estate management application, the system comprising:
a processor;
a memory configured to store a set of instructions, which when executed by the processor cause the system to perform a method, the method including:
retrieving a plurality of contacts for placement within a call initiation queue of the dialer application, wherein each of the plurality of contacts is indicative of a client a real estate agent intends to establish communication with via the electronic real estate management application;
assigning a priority value for at least a subset of the retrieved contacts based on one or more priority bases associated with the real estate management application;
automatically arranging the plurality of contacts within the call initiation queue in a specific order based on the priority value associated with each of the plurality of contacts; and
initiating communication with one or more of the plurality of contacts by the embedded dialer application according to the specific order of the contacts within the call initiation queue.

20. The system of claim 19, wherein the one or more priority bases associated with the real estate management application includes at least one of:
a priority based on one or more clients designated as priority contacts;
a priority based on one or more clients designated as emerging stars;
a priority based on one or more clients designated as users of a mobile version of a client real estate management application;
a priority based on one or more clients designated as having made a recent offer for purchase of a real estate property;
a priority based on one or more clients designated as having made a recent tour of a home in a neighborhood associated with the real estate agent;
a priority based on one or more clients designated as having elected to receive calls at a specific time duration;
a priority based on the real estate agent's current geographic location;
a priority based on a current geographic location of one or more clients;
a priority based on specific reminders assigned by the real estate agent to one or more clients; or
a priority based on an increase in real estate activity of one or more clients.

21. A system for initiation and placement of telephone calls using an embedded dialer application in an electronic real estate management application, the system comprising:
storage means for storing a plurality of contacts for placement within a call initiation queue of the dialer application, wherein each of the plurality of contacts is indicative of a client a real estate agent intends to establish communication with via the electronic real estate management application
computing means for operating the dialer application within the electronic real estate management application, the computing means for:
retrieving the plurality of contacts for placement from the database;
assigning a priority value for at least a subset of the retrieved contacts based on one or more priority bases associated with the real estate management application;
automatically arranging the plurality of contacts within the call initiation queue in a specific order based on the priority value associated with each of the plurality of contacts; and
initiating communication with one or more of the plurality of contacts by the embedded dialer application according to the specific order of the contacts within the call initiation queue.
